(19) United States
(12) Patent Application Publication
(10) Pub. No.: US 2025/0035573 A1
(43) Pub. Date: Jan. 30, 2025

(54) METHOD FOR PREDICTING RELIABILITY OF CROSS-LINKED POLYETHYLENE CABLE INSULATION MATERIAL

(71) Applicant: ELECTRIC PWR. RES. INST., CHINA SOUTH. PWR. GRID, Guangzhou (CN)

(72) Inventors: Shuai HOU, Guangzhou (CN); Mingli FU, Guangzhou (CN); Xiaolin LI, Guangzhou (CN); Yunpeng ZHAN, Guangzhou (CN); Wenbo ZHU, Guangzhou (CN); Baojun HUI, Guangzhou (CN); Bin FENG, Guangzhou (CN); Yifan ZHANG, Guangzhou (CN)

(73) Assignee: ELECTRIC PWR. RES. INST., CHINA SOUTH. PWR. GRID, Guangzhou, OT (CN)

(21) Appl. No.: 18/282,366

(22) PCT Filed: Nov. 9, 2022
(86) PCT No.: PCT/CN2022/130863

§ 371 Date: Sep. 15, 2023

(30) Foreign Application Priority Data
Mar. 22, 2022 (CN) 202210283709.1

(51) Int. Cl. G01N 25/48

(52) U.S. Cl. CPC G01N 25/4846; G01N 2203/0092

(57) ABSTRACT

A method for predicting reliability of a cross-linked polyethylene cable insulation material, including: subjecting cross-linkable materials respectively to cross-linking reactions, to obtain groups of cross-linked polyethylene and enthalpy values of exothermic peaks of cross-linking reactions of the groups of cross-linkable materials; subjecting the groups of cross-linked polyethylene to a thermal extension test to obtain elongations under load of the groups of cross-linked polyethylene; establishing a curve for predicting reliability of the cross-linked polyethylene cable insulation material based on enthalpy values of the exothermic peaks of cross-linking reactions of the groups of cross-linkable materials and the elongations under load of the groups of cross-linked polyethylene; subjecting a cross-linkable material to be predicted to a cross-linking reaction, thereby obtaining an enthalpy value of an exothermic peak of the cross-linking reaction of the cross-linkable material to be predicted; and comparing the enthalpy value of the exothermic peak with a standard enthalpy value.

### CROSS-REFERENCE TO RELATED APPLICATIONS

This application claims priority to Chinese patent application No. 2022102837091, filed with the China National Intellectual Property Administration on Mar. 22, 2022, entitled “METHOD FOR PREDICTING RELIABILITY OF CROSS-LINKED POLYETHYLENE CABLE INSULATION MATERIAL”, the content of which is hereby incorporated by reference in its entirety.

### TECHNICAL FIELD

The present disclosure belongs to the technical field of cables, and in particular relates to a method for predicting reliability of a cross-linked polyethylene cable insulation material.

### BACKGROUND

Cross-linked polyethylene insulation materials are widely used as insulation materials of insulation layers for long-distance electric power transmission overhead lines and urban underground cables due to excellent electrical properties of cross-linked polyethylene (XLPE).

In preparation of cross-linked polyethylene, linear molecular chains are linked to form a cross-linked polyethylene insulation material with a network structure and excellent electrical properties via active free radicals generated by decomposition of a cross-linking agent. Before being used in the manufacture of cross-linked polyethylene cable insulation layers, the cross-linking agent in cross-linkable material granules would spontaneously decompose due to the temperature of storage, the time period for storage, or the like. The cross-linking agent such as dicumyl peroxide needs to be stored under the conditions of low temperature and dark light, and decomposition half-life thereof decreases exponentially with the increase of temperature. Therefore, the cross-linkable material granules stored under different storage conditions will affect a cross-linking degree of the cross-linking reaction, and an elongation under load of cross-linked polyethylene is closely related to the cross-linking degree. Thus, the cross-linked polyethylene prepared from the cross-linkable material granules stored under different storage conditions has different elongations under load.

The cable insulation layers made of cross-linked polyethylene with relatively high elongations under load may be unreliable. XLPE materials for 220 kV cable insulation should have an elongation under load not more than 100%, as specified in the section of thermal extension test in GB/T 18890.2-2015. At present, the reliability evaluation of a cross-linked polyethylene cable insulation material involves tests such as the thermal extension test on the cross-linked polyethylene cable insulation material, lacking a predicting method.

### SUMMARY

In view of this, the present disclosure provides a method for predicting reliability of a cross-linked polyethylene cable insulation material. According to this method, an enthalpy value of an exothermic peak of a cross-linking reaction of a cross-linkable material is calculated, and an elongation under load of the cross-linked polyethylene cable insulation material is determined based on the negative correlation between the enthalpy value and the elongation under load of the cross-linked polyethylene cable insulation material, thereby rapidly predicting reliability of the cross-linked polyethylene cable insulation material, and solving the technical problem of lacking a method for predicting reliability of a cross-linked polyethylene cable insulation material in the related art.

In a first aspect, the present disclosure provides a method for predicting reliability of a cross-linked polyethylene cable insulation material, including:
step 1, subjecting multiple groups of cross-linkable materials respectively to cross-linking reactions, thereby obtaining multiple groups of cross-linked polyethylene and enthalpy values of exothermic peaks of the cross-linking reactions of the multiple groups of cross-linkable materials;
step 2, subjecting the multiple groups of cross-linked polyethylene to a thermal extension test to obtain elongations under load of the multiple groups of cross-linked polyethylene;
step 3, establishing a curve for predicting reliability of the cross-linked polyethylene cable insulation material on the basis of the enthalpy values of the exothermic peaks of the cross-linking reactions of the multiple groups of cross-linkable materials and the elongations under load of the multiple groups of cross-linked polyethylene;
step 4, subjecting a cross-linkable material to be predicted to a cross-linking reaction, thereby obtaining an enthalpy value of an exothermic peak of the cross-linking reaction of the cross-linkable material to be predicted; and
step 5, comparing the enthalpy value of the exothermic peak of the cross-linking reaction of the cross-linkable material to be predicted with a standard enthalpy value,
wherein the cross-linkable material includes a cross-linking agent and polyethylene.

Preferably, after the step 5, the method further includes:
step 6, inputting the enthalpy value of the exothermic peak of the cross-linking reaction of the cross-linkable material to be predicted into the curve for predicting reliability of the cross-linked polyethylene cable insulation material, to obtain an elongation under load of cross-linked polyethylene to be predicted; and
step 7, comparing the elongation under load of cross-linked polyethylene to be predicted with a standard value.

It should be noted that the standard value in the present disclosure can be a standard value of the elongation under load, less than 100%, of a XLPE material for 220 kV cable insulation as specified in the section of thermal extension test in GB/T 18890.2-2015. Alternatively, the standard value can be a custom standard value, or a standard value defined by other national standards. The standard enthalpy value in the present disclosure is 8.08655 J/g.

Preferably, the curve for predicting reliability of the cross-linked polyethylene cable insulation material is a curve for predicting elongation under load of cross-linked polyethylene.

It should be noted that the curve for predicting elongation under load of cross-linked polyethylene is established by taking the enthalpy value as a horizontal axis and taking the elongation under load of cross-linked polyethylene as a vertical axis.

Preferably, the subjecting multiple groups of cross-linkable materials respectively to cross-linking reactions, thereby obtaining multiple groups of cross-linked polyethylene and enthalpy values of exothermic peaks of the cross-linking reactions of the multiple groups of cross-linkable materials includes:
subjecting the multiple groups of cross-linkable materials respectively to the cross-linking reactions in a differential scanning calorimeter, thereby obtaining the multiple groups of cross-linked polyethylene and the enthalpy values of the exothermic peaks of the cross-linking reactions of the multiple groups of cross-linkable materials.

Preferably, the obtaining enthalpy values of exothermic peaks of the cross-linking reactions of the multiple groups of cross-linkable materials includes:
obtaining the enthalpy values of the exothermic peaks of the cross-linking reactions of the multiple groups of cross-linkable materials on the basis of integral regions of heat flow-time graphs generated by the differential scanning calorimeter.

Preferably, the integral region of the heat flow-time graph is calculated by: taking a heat flow curve before the exothermic peak of the cross-linking reaction occurs as a baseline, and taking tangent points between the baseline and the heat flow curve as upper and lower limits for integration.

Preferably, the cross-linking agent is a peroxide.

Preferably, the peroxide is dicumyl peroxide.

Preferably, the subjecting the multiple groups of cross-linkable materials respectively to the cross-linking reactions in a differential scanning calorimeter includes:
subjecting the multiple groups of cross-linkable materials each with a mass of 5 mg to 10 mg and a size of 0.5 mm×0.5 mm×0.5 mm to the cross-linking reactions respectively in a crucible of the differential scanning calorimeter.

Preferably, the subjecting the multiple groups of cross-linkable materials respectively to the cross-linking reactions in a differential scanning calorimeter includes:
purging the differential scanning calorimeter with nitrogen gas, and then subjecting the multiple groups of cross-linkable materials each with a mass of 5 mg to 10 mg and a size of 0.5 mm×0.5 mm×0.5 mm to the cross-linking reactions respectively in a crucible specific for the differential scanning calorimeter.

Preferably, the nitrogen gas has a purity greater than 99.999%.

To sum up, the present disclosure provides a method for predicting reliability of a cross-linked polyethylene cable insulation material. The prediction method includes: subjecting multiple groups of cross-linkable materials to cross-linking reaction, thereby obtaining multiple groups of cross-linked polyethylene and enthalpy values of exothermic peaks of the cross-linking reactions of the multiple groups of cross-linkable materials; then establishing a curve for predicting reliability of the cross-linked polyethylene cable insulation material; and obtaining an enthalpy value of an exothermic peak of the cross-linking reaction of the cross-linkable material to be predicted, and inputting the enthalpy value into the curve for predicting reliability of the cross-linked polyethylene cable insulation material, to obtain an elongation under load of cross-linked polyethylene. Among them, during the cross-linking reactions of the multiple groups of cross-linkable materials, the cross-linkable material granules absorb heat violently to melt the polyethylene resin, and meanwhile the cross-linking agent DCP gradually decomposes. As the temperature rises, the cross-linking reaction begins. A relatively weak exothermic peak of the cross-linking reaction occurs in the heat flow curve. The intensity of the exothermic peak is positively correlated to the degree of completion of the cross-linking reaction. Thus, the activity of different cross-linkable materials can be evaluated by calculating the enthalpy values of the exothermic peaks of the cross-linking reactions of the different cross-linkable materials during the heating process. The cross-linkable materials with different activities will affect the cross-linking degrees of the cross-linking reactions. The elongation under load and the cross-linking degree of cross-linked polyethylene are closely related, specifically in a directly proportional relationship. That is, the lower the activity of the cross-linkable material granules, the greater the elongation under load of cross-linked polyethylene. Therefore, in the present disclosure, the enthalpy value of the exothermic peak of the cross-linking reaction of the cross-linkable material is calculated, and the elongation under load of the cross-linked polyethylene cable insulation material is determined based on the negative correlation between the enthalpy value of the cross-linkable material and the elongation under load of the cross-linked polyethylene cable insulation material. When the elongation under load is lower than the standard value, it is determined that the cross-linked polyethylene cable insulation material prepared by the cross-linked polyethylene is unreliable, and it is not necessary to further conduct the thermal extension test. Accordingly, the reliability of the cross-linked polyethylene cable insulation material can be rapidly predicted, thereby solving the technical problem of lacking a method for predicting reliability of a cross-linked polyethylene cable insulation material in the related art.

### BRIEF DESCRIPTION OF THE DRAWINGS

To illustrate examples of the present disclosure or the technical solutions in the prior art more clearly, the following briefly introduces the drawings that are required in the description of the examples of the present disclosure or the prior art. Apparently, the drawings in the following description are only some examples of the present disclosure. Those skilled in the art can obtain other drawings according to these drawings without any creative effort.

FIG. 1 shows a schematic flow chart of a method for predicting reliability of a cross-linked polyethylene cable insulation material in Example 3 of the present disclosure.

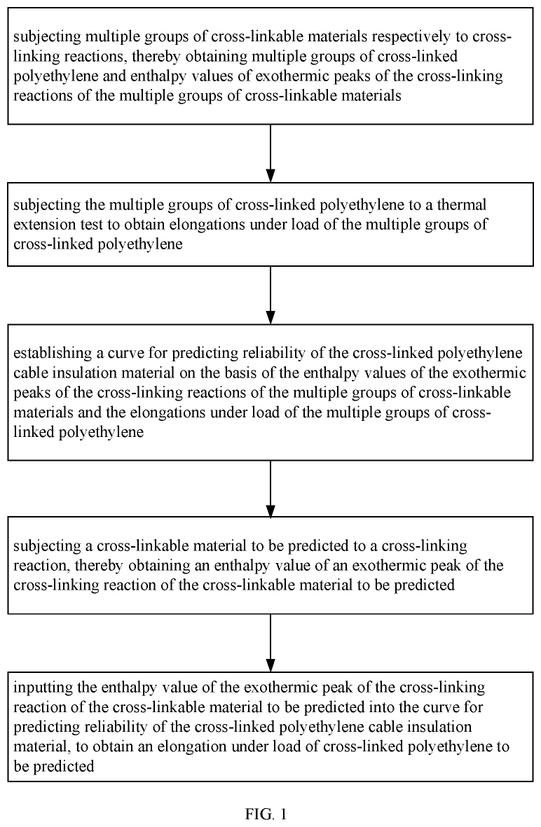

FIG. 2 is a schematic diagram showing a method for calculating an enthalpy value of an exothermic peak of a cross-linking reaction of a cross-linkable material in Example 1 of the present disclosure.

FIG. 3 is a schematic diagram showing a curve for predicting reliability of a cross-linked polyethylene cable insulation material established in Example 2 of the present disclosure.

### DETAILED DESCRIPTION

The present disclosure provides a method for predicting reliability of a cross-linked polyethylene cable insulation material. According to this method, an enthalpy value of an exothermic peak of a cross-linking reaction of a cross-linkable material is calculated, and an elongation under load of a cross-linked polyethylene cable insulation material is determined based on the correlation between the enthalpy value of the cross-linkable material and the elongation under load of the cross-linked polyethylene cable insulation material, thereby rapidly predicting reliability of the cross-linked polyethylene cable insulation material, and solving the technical problem of lacking a method for predicting reliability of a cross-linked polyethylene cable insulation material in the related art.

The following will clearly and completely describe the technical solutions in the examples of the present disclosure. Obviously, the described examples are only some of the examples of the present disclosure, rather than all the examples. Based on the examples in the present disclosure, all other examples obtained by ordinary skilled in the art without creative efforts belong to the protection scope of the present disclosure.

The reagents or raw materials used in the following examples are all commercially available or self-made.

### Example 1

Example 1 provides a method for calculating an enthalpy value of an exothermic peak of a cross-linking reaction of a cross-linkable material, including the following steps.
1.1 Multiple groups of cross-linkable material granules were cut into pieces in a size of 0.5 mm×0.5 mm×0.5 mm, and the resulting pieces were placed in an aluminum crucible specific for differential scanning calorimetry (DSC), with 5 mg to 10 mg of the materials for each DSC experiment. The pieces were placed to be in good contact with the bottom of the crucible. The crucible cover was covered on the crucible and pressed for sealing. Thus, the samples required for the DSC experiment were prepared.
1.2 The crucible containing the cross-linkable material and a reference crucible without cross-linkable material (i.e., an empty crucible) were placed on a sample rack in the instrument for DSC experiment. The experimental procedure includes two heating processes, in which the second heating process is to confirm the experimental effect of the first heating process. The temperature was raised from 30° C. to 220° C. at a heating rate of 10° C./min during each heating process. The heat flow flowing through the sample and the heat flow flowing through the empty crucible were measured during the heating process. Accordingly, the heat flow flowing through the cross-linkable material was obtained.
1.3 A heat flow-time graph was drawn according to the heat flow data of the sample measured by the instrument for DSC experiment during the first heating process so as to calculate the exothermic enthalpy of the cross-linking reaction.

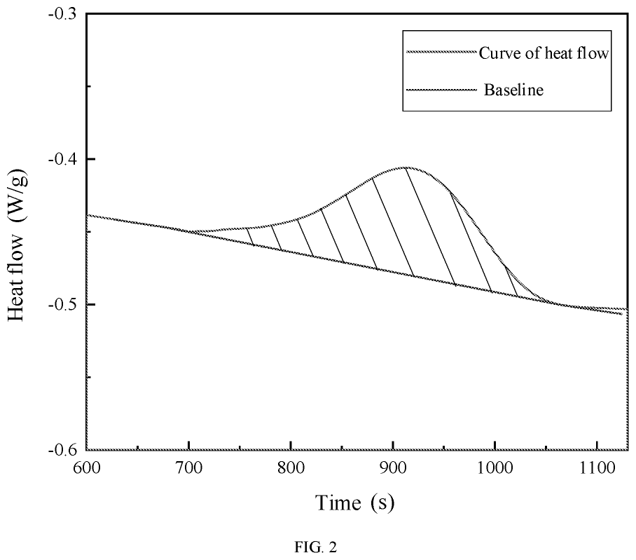

The heat flow curve before the exothermic peak of the cross-linking reaction occurs was taken as a baseline, and tangent points between the baseline and the heat flow curve were taken as upper and lower limits for integration. The exothermic enthalpy of the cross-linking reaction of the cross-linkable material during the entire heating process was obtained by integrating the area of the closed region, such as the shaded area of FIG. 2.

The sample should be weighed with an accuracy of 0.01 mg, and the difference of mass between the fresh granules and the stored granules should be less than 5%. Meanwhile, the nitrogen gas for purging the working environment of the instrument for DSC experiment has a purity equal to or greater than 99.999%, so as to avoid oxidation reaction of the sample during the heating-melting and cooling-crystallization processes, thereby preventing from affecting the accuracy of experiments. If the exothermic enthalpy of the cross-linking reaction of a sample calculated from the heat flow curve is greater than 0.1 J/g during the second heating process, it indicates that the cross-linkable material of the same sample is not cross-linked sufficiently during the first heating process, and the experiment needs to be performed again.

### Example 2

Example 2 is an example for establishing the curve for predicting reliability of the cross-linked polyethylene cable insulation material based on the enthalpy value of the exothermic peak of the cross-linking reaction of the cross-linkable material and the elongation under load of the cross-linkable material.
Step 1. The cross-linkable material granules which are respectively fresh, stored for one year, five years, and ten years, for 220 kV high voltage cross-linked cable insulation layer were each subjected to a cross-linking reaction in a differential scanning calorimeter, thereby obtaining cross-linked polyethylene prepared from the cross-linkable material granules, which are fresh, stored for one year, five years, and ten years respectively, and obtaining enthalpy values of the exothermic peaks of the cross-linking reactions of the cross-linkable material granules, which are fresh, stored for one year, five years, and ten years respectively. The calculation of the enthalpy value of the exothermic peak of the cross-linking reaction of the cross-linking material is referred to Example 1. The specific values are shown in Table 1.
Step 2. The cross-linked polyethylene prepared from the cross-linkable material granules, which are fresh, stored for one year, five years, and ten years respectively, was subjected to the thermal extension test according to the national standard GB/T 18890.2-2015. The specific values are shown in Table 2.

TABLE 1

| | Exothermic enthalpy during |
|---|---|
| Material | cross-linking reaction J/g |
| Fresh granules | 9.08 |
| Stored for one year | 8.56 |
| Stored for five years | 6.70 |
| Stored for ten years | 6.33 |

TABLE 2

| Material | Elongation under load/% |
|---|---|
| Fresh granules | 55 |
| Stored for one year | 80 |
| Stored for five years | 161.67 |
| Stored for ten years | The sample is fused |

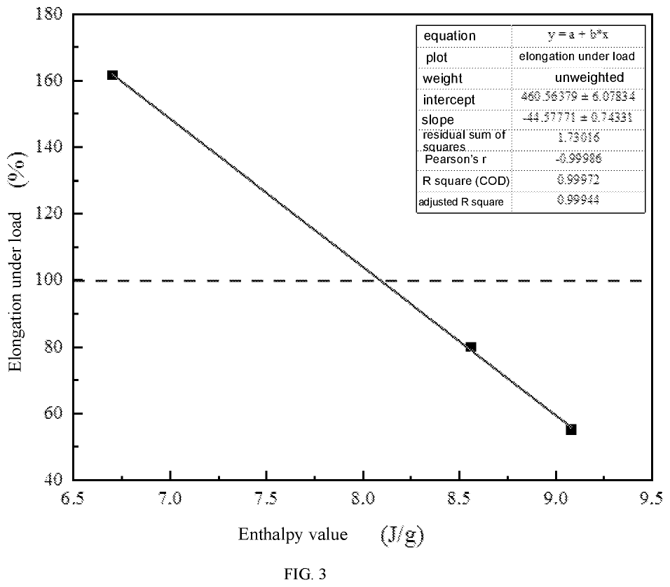

It can be seen from Tables 1 and 2 that the exothermic peak of the cross-linking reaction of the cross-linkable material measured in the DSC experiment weakens and the exothermic enthalpy thereof gradually decreases with the increase of the storage time. It is measured that the exothermic enthalpy of the cross-linking reaction of the cross-linkable material decreases by about 30% when the cross-linkable material has been stored for five years, because the DCP in the cross-linkable material gradually decomposes and the activity of the cross-linkable material decreases during the long-term storage, which results in insufficient cross-linking reaction of the cross-linkable material when the temperature rises to the temperature for cross-linking reaction. Meanwhile, from the results of thermal extension test in Table 2, it can be seen that the elongation under load of the cross-linkable material measured in the thermal extension test gradually increases with the increase of the storage time. That is, the elongation under load of the cross-linked polyethylene can be determined on the basis of the enthalpy values of the cross-linking reactions of the multiple groups of cross-linked materials obtained by the differential scanning calorimeter. Since the enthalpy value is negatively correlated to the elongation under load of the cross-linked polyethylene, a curve for predicting reliability of the cross-linked polyethylene cable insulation material can be established on the basis of the enthalpy values of the exothermic peaks of the cross-linking reactions of the cross-linkable material granules, which are fresh, stored for one year, five years, and ten years respectively, and the elongations under load of the multiple groups of cross-linked polyethylene. The curve for predicting reliability shown in FIG. 3 can be obtained on the basis of the existing experimental data. It can be seen from FIG. 3 that the elongation under load of cross-linked polyethylene is linearly correlated to the enthalpy value. Thus, a characteristic equation between the elongation under load and the enthalpy value can be obtained by curve fitting. In FIG. 3, the horizontal dotted line indicates a standard line of a 100% elongation under load, and the enthalpy value at the intersection point between the horizontal dotted line and the fitted straight line is 8.08655 J/g. Therefore, in this example, the activity of the cross-linkable material can be regarded as still meeting requirements when the exothermic enthalpy value of the cross-linking reaction of the cross-linkable material to be predicted is greater than 8.08655 J/g as measured, and thus the reliability of the cross-linked polyethylene cable insulation material prepared by the cross-linkable material can be regarded as meeting the national standard.

### Example 3

Example 3 provides a method for predicting reliability of the cross-linked polyethylene cable insulation material, including the following steps.
Step 1. The cross-linkable material granules which are respectively fresh, stored for one year, five years, and ten years respectively were each subjected to a cross-linking reaction, thereby obtaining four groups of cross-linked polyethylene and enthalpy values of the exothermic peaks of cross-linking reactions of the four groups of cross-linkable materials. The calculation of the enthalpy value of the exothermic peak of the cross-linking reaction of the cross-linkable material is referred to Example 1. The specific values are shown in Table 1.
Step 2. The cross-linked polyethylene prepared from the cross-linkable material granules, which are fresh, stored for one year, five years, and ten years respectively were subjected to thermal extension test, thereby obtaining elongations under load of the cross-linked polyethylene prepared from the granules which are fresh, stored for one year, five years, and ten years respectively. The specific elongations under load are shown in Table 2.
Step 3. A curve for predicting reliability of the cross-linked polyethylene cable insulation material is established on the basis of the enthalpy values of the exothermic peaks of the cross-linking reactions of the multiple groups of cross-linkable materials and the elongations under load of the multiple groups of cross-linked polyethylene. Specifically, the enthalpy value is negatively correlated to the elongation under load of the cross-linked polyethylene, therefore the curve for predicting reliability of the cross-linked polyethylene cable insulation material is established on the basis of the enthalpy values of the exothermic peaks of the cross-linking reactions of the cross-linkable material granules which are fresh, stored for one year, five years, and ten years respectively, and the elongations under load of the multiple groups of cross-linked polyethylene.
Step 4. A cross-linkable material to be predicted was subjected to a cross-linking reaction, thereby obtaining an enthalpy value of the exothermic peak of the cross-linking reaction of the cross-linkable material to be predicted. The cross-linkable material to be predicted is a cross-linkable material stored for any period, stored at any temperature, or stored under other storage conditions.
Step 5. The enthalpy value of the exothermic peak of the cross-linking reaction of the cross-linkable material to be predicted was input into the curve for predicting reliability of the cross-linked polyethylene cable insulation material, to obtain an elongation under load of the cross-linked polyethylene to be predicted.

It should be noted that, in the process of heating the cross-linkable material granules, the granules absorb heat violently before the temperature rises to 110° C., so that an endothermic peak obviously appears in the heat flow curve of DSC. At this stage, the cross-linking agent DCP gradually decomposes as the polyethylene resin in the cross-linkable material melts. With the further increase of the temperature, the cross-linking reaction begins, and a relatively weak exothermic peak of the cross-linking reaction appears in the heat flow curve. The intensity of the exothermic peak is positively correlated to the degree of completion of the cross-linking reaction. Therefore, the intensity of cross-linking degree can be evaluated by calculating the enthalpy values of the exothermic peaks of the cross-linking reactions of different cross-linkable materials during the heating process, and thus the thermal extension performance of XLPE materials can be predicted. Compared to the related art, the correlation between the exothermic enthalpy of the cross-linking reaction of the cross-linkable material obtained through the DSC experiment and the thermal elongation performance of the obtained XLPE material is adopted in the present disclosure, thereby realizing prediction of reliability of cross-linked polyethylene in a flexible and rapid manner.

The various technical features of the above-mentioned examples can be combined arbitrarily. All possible combinations of various technical features in the above-mentioned examples are not described for concise description. However, the combinations of these technical features should be considered as within the scope of this specification as long as no contradiction exists in these combinations.

The above-mentioned examples that are specifically described in detail only express several embodiments of the present disclosure, but they should not be construed as limiting the scope of the present disclosure. It should be noted that several modifications and improvements can be made by those skilled in the art without departing from the concept of the present disclosure, and they all belong to the protection scope of the present disclosure. Therefore, the protection scope of the present disclosure shall be based on the appended claims, and the description and drawings may be used to explain the contents of the claims.

1. A method for predicting reliability of a cross-linked polyethylene cable insulation material, comprising:
step 1, subjecting multiple groups of cross-linkable materials respectively to cross-linking reactions, thereby obtaining multiple groups of cross-linked polyethylene and enthalpy values of exothermic peaks of the cross-linking reactions of the multiple groups of cross-linkable materials;
step 2, subjecting the multiple groups of cross-linked polyethylene to a thermal extension test to obtain elongations under load of the multiple groups of cross-linked polyethylene;
step 3, establishing a curve for predicting reliability of the cross-linked polyethylene cable insulation material on the basis of the enthalpy values of the exothermic peaks of the cross-linking reactions of the multiple groups of cross-linkable materials and the elongations under load of the multiple groups of cross-linked polyethylene;
step 4, subjecting a cross-linkable material to be predicted to a cross-linking reaction, thereby obtaining an enthalpy value of an exothermic peak of the cross-linking reaction of the cross-linkable material to be predicted; and
step 5, comparing the enthalpy value of the exothermic peak of the cross-linking reaction of the cross-linkable material to be predicted with a standard enthalpy value,
wherein the cross-linkable material comprises a cross-linking agent and polyethylene.

2. The method according to claim 1, wherein after the step 5, the method further comprises:
step 6, inputting the enthalpy value of the exothermic peak of the cross-linking reaction of the cross-linkable material to be predicted into the curve for predicting reliability of the cross-linked polyethylene cable insulation material, to obtain an elongation under load of cross-linked polyethylene to be predicted; and
step 7, comparing the elongation under load of cross-linked polyethylene to be predicted with a standard value.

3. The method according to claim 1, wherein the subjecting multiple groups of cross-linkable materials respectively to cross-linking reactions, thereby obtaining multiple groups of cross-linked polyethylene and enthalpy values of exothermic peaks of the cross-linking reactions of the multiple groups of cross-linkable materials comprises:
subjecting the multiple groups of cross-linkable materials respectively to the cross-linking reactions in a differential scanning calorimeter, thereby obtaining the multiple groups of cross-linked polyethylene and the enthalpy values of the exothermic peaks of the cross-linking reactions of the multiple groups of cross-linkable materials.

4. The method according to claim 3, wherein the obtaining enthalpy values of exothermic peaks of the cross-linking reactions of the multiple groups of cross-linkable materials comprises:
obtaining the enthalpy values of the exothermic peaks of the cross-linking reactions of the multiple groups of cross-linkable materials on the basis of integral regions of heat flow-time graphs generated by the differential scanning calorimeter.

5. The method according to claim 4, wherein the integral regions of the heat flow-time graphs are each calculated by:
taking a heat flow curve before the exothermic peak of the cross-linking reaction occurs as a baseline, and taking tangent points between the baseline and the heat flow curve as upper and lower limits for integration.

6. The method according to claim 1, wherein the cross-linking agent is a peroxide.

7. The method according to claim 6, wherein the peroxide is dicumyl peroxide.

8. The method according to claim 3, wherein the subjecting the multiple groups of cross-linkable materials respectively to the cross-linking reactions in a differential scanning calorimeter comprises:
subjecting the multiple groups of cross-linkable materials each with a mass of 5 mg to 10 mg and a size of 0.5 mm×0.5 mm×0.5 mm to the cross-linking reactions respectively in a crucible of the differential scanning calorimeter.

9. The method according to claim 8, wherein the subjecting the multiple groups of cross-linkable materials respectively to the cross-linking reactions in a differential scanning calorimeter comprises:
purging the differential scanning calorimeter with nitrogen gas, and then subjecting the multiple groups of cross-linkable materials each with a mass of 5 mg to 10 mg and a size of 0.5 mm×0.5 mm×0.5 mm to the cross-linking reactions respectively in a crucible of the differential scanning calorimeter.

10. The method according to claim 9, wherein the nitrogen gas has a purity greater than 99.999%.
